(19) United States
(12) Patent Application Publication
(10) Pub. No.: US 2009/0085368 A1
(43) Pub. Date: Apr. 2, 2009

(54) TACTICAL TRUCK SYSTEM DASHBOARD

(75) Inventors: David J. Coffelt, Owego, NY (US); Jeffrey B. Colburn, Harpursville, NY (US); Gary Crowley, Binghamton, NY (US); Charles T. DiSaverio, Apalchin, NY (US); John J. Ford, Binghamton, NY (US); Douglas J. Hines, Endicott, NY (US); Charles J. Maira, Owego, NY (US); Shane F. Mills, Owego, NY (US); David L. Ricketson, Owego, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/201,375

(22) Filed: Aug. 29, 2008

Related U.S. Application Data
(63) Continuation-in-part of application No. 11/430,462, filed on May 9, 2006, now Pat. No. 7,425,891.

(51) Int. Cl. B62D 25/14

(52) U.S. Cl. 296/70

(57) ABSTRACT

A dashboard for a tactical vehicle having a driver position and a passenger position. The dashboard includes a plurality of panels removably attached together to form a dashboard having a plurality of displays and warning lights viewable from the driver position to provide information for the driver of a vehicle. One of the panels is located in front of the vehicle driver position and has a driver instrument cluster.

### REFERENCE TO RELATED APPLICATIONS

The present application is a continuation in part of Ser. No. 11/430,462 filed on May 9, 2006, the substance of which is incorporated herein by reference, and the benefit of which is hereby claimed.

### FIELD OF THE INVENTION

This invention relates generally to the vehicle art, and, more particularly to tactical truck system dashboards.

### BACKGROUND OF THE PRESENT INVENTION

The following patents and published applications relate to the subject matter of the present invention;

U.S. Pat. No. Des. 82,501 dated Nov. 11, 1930;

U.S. Pat. No. Des. 100,173 dated Jun. 23, 1936;

U.S. Pat. No. Des. 156,455 dated Dec. 13, 1939;

U.S. Pat. No. Des. 209,957 dated Jun. 23, 1968;

U.S. Pat. No. Des. 339,786 dated Sep. 28, 1993;

U.S. Pat. No. Des. 378,585 dated Mar. 25, 1997;

U.S. Pat. No. Des. 395,030 dated Jun. 9, 1998;

U.S. Pat. No. Des. 397,977 dated Sep. 8, 1998;

U.S. Pat. No. Des. 413,095 dated Aug. 24, 1999;

U.S. Pat. No. Des. 423,434 dated Apt. 25, 2000;

U.S. Pat. No. D427,613 dated July, 2000;

U.S. Pat. D439,556 S dated Mar. 27, 2001;

U.S. Pat. D440,924 S dated Apr. 24, 2001;

U.S. Pat. No. D449,263 dated October, 2001;

U.S. Pat. No. D480,029 S dated Sep. 30, 2003;

U.S. Pat. No. D489,301 S dated May 4, 2004;

U.S. Pat. No. D493,395 dated July, 2004;

U.S. Pat. No. D494,518 S Aug. 17, 2004;

U.S. Pat. No. D501,811 dated February 2006;

U.S. Pat. No. D514,995 dated February, 2006;

U.S. Pat. No. D515,487 dated February, 2006;

U.S. Pat. No. D534,468 S dated Jan. 2, 2007 discloses a design for a dashboard;

U.S. Pat. No. 5,174,621 dated Dec. 29, 1992;

U.S. Pat. No. 5,259,655 dated Nov. 9, 1993;

U.S. Pat. No. 5,743,585 dated Apr. 28, 1998;

U.S. Pat. No. 5,890,756 dated Apr. 6, 1999;

U.S. Pat. No. 5,903,227 dated May, 1999;

U.S. Pat. No. 6,112,141 dated August 2000;

U.S. Pat. No. 6,381,519 dated April, 2002;

U.S. Pat. No. 6,421,593 dated July, 2002;

U.S. Pat. No. 6,668,215 dated December 2003;

U.S. Pat. No. 7,307,549 dated December 2007;

U.S. Published Appln, No. 2005/0280524 dated December 2005;

EP publication 0 083 701 A2 published Jul. 20, 1983 for a dashboard having in modular elements;

German 39 2 678 dated Aug. 9, 1990 discloses a vehicle dashboard arrangement;

EP publication 0 433 524 A1 published Jun. 26, 1991, is for an information panel for a driver and a storage compartment; and

EP 0 607 585 A1 published Jul. 27, 1994, discloses a dashboard for vehicles having a body at the base of the windshield and supports a set of indicating instruments and warning devices and controls.

### SUMMARY OF THE PRESENT INVENTION

The present invention restructures the dashboard components of tactical vehicles to better accommodate and/or reduce the driver and passenger interface and/or workload.

There is a desire for a basic tactical truck systems utility vehicle which is a 4×4 wheeled vehicle which incorporates features needed to support the requirements of a combat system. There are several types of such vehicles that are desired, one of which is a command and control vehicle. Such vehicles will be operating on primary and secondary roads, trails and off road ground conditions. They are to be capable of fording water and operating in temperature from basic cold to basic hot conditions. With appropriate adjustment they are to be capable of operating in extreme cold conditions and to be capable of traveling through deep water, such as streams. Also, the vehicle may have a companion trailer which it tows and which performs differing functions depending upon the type of activity being conducted.

The present invention provides for rapid combat egress from a tactical vehicle. Egress from a combat vehicle, especially during combat, is different than egress from a non-combat vehicle. In combat, a soldier may need to obtain egress within a three second period. Accomplishing this presents certain difficulties. One of these is the equipment that a soldier is wearing during combat, one being a protective vest which may contain protective plates made of material such as ceramic. Also, such a vest has pockets to carry extra ammunition. Further there is padding inside the vest. This adds 1 and ½ inches or more to the body perimeter. During combat, the soldier/driver may need to quickly leave the vehicle, but could be delayed in doing this due in part to the position of the steering column. The steering column, according to the present invention is arranged to be tilted up and away from the driver and this can be for example at an upward angle of 20 degrees.

In the command and control type vehicle, there needs to be a provision for a driver and a command person and thus a dashboard that provides information to each of them to allow them to perform their designated functions. The present invention provides a dashboard having three primary sections. The first section is on the driver's side and provides the usual types of displays and controls typically found in commercial and military vehicles. An example of these functions are speed and rpm as well as fuel levels and the conditions of the hydraulic system and the tires. The next section, which is the third section, is on the side of the vehicle next to the command position and the middle or second section is between the first and third sections. The middle section is visible to and usable by both the driver, commander and the gunner if the vehicle is equipped for a gunner.

The dials, gauges and other displays as well as the controls, which can be push buttons or sliders or gear shifts, depending upon the functions desired, are provided in the three sections of the dashboard. These sections can be configured depending on the mission profile and those control options that are required by function, which can be driven by the requirements of that particular truck variant. The present invention provides a vehicle dashboard system that has incorporated standard and new advance vehicle operational controls as well as looking at crew logical workload sharing and related ergonomics. It provides a vehicle dashboard system that can be configured to incorporate different controls that are required depending on different utility variant configuration.

The present invention together with the above and other advantages may best be understood from the following detailed description of the embodiments of the invention illustrated in the drawings, wherein:

### BRIEF DESCRIPTION OF THE DRAWINGS

FIG. 1 is a front view of a first embodiment of the present invention.

FIG. 2 is an isometric diagrammatic view of the dashboard embodiment shown in FIG. 1

FIG. 3 is a front view of a second embodiment of the present invention.

FIG. 4 is an isometric diagrammatic view of the second embodiment of the present invention shown in FIG. 3.

FIG. 5 is a front view of the third embodiment of the present invention.

FIG. 6 is an isometric diagrammatic view of the third embodiment of the present invention shown in FIG. 5.

FIG. 7 is a side view of the dashboard of the first embodiment of FIGS. 1 and 2.

FIG. 8 is a side view of the dashboard of the second embodiment of FIGS. 3 and 4.

FIG. 9 is a side view of the dashboard of the third embodiment of FIGS. 5 and 6.

FIG. 10 is an isometric diagrammatic view of another embodiment of the dashboard as viewed from the driver's side (left).

FIG. 11 is an isometric view similar to FIG. 10, but taken from a position in the middle of the front seat of the vehicle.

FIG. 12 is an isometric view similar to FIGS. 10 and 11, but taken from the command position.

FIG. 13 is a diagrammatic view of the driver's front view panel of the FIG. 10 embodiment.

FIG. 14 is a diagrammatic view of the driver's front functions panel of the FIG. 10 embodiment.

FIG. 15 is a diagrammatic view of the driver's left display panel of the FIG. 10 embodiment.

FIG. 16 is a diagrammatic view of the driver's right display panel of the FIG. 10 embodiment.

FIG. 17 is a diagrammatic view of the driver's side view panel of the FIG. 10 embodiment.

FIG. 18 is a diagrammatic view of the common area instrument cluster panel of the FIG. 10 embodiment.

FIG. 19 is a diagrammatic view of the commander's side instrument panel of the FIG. 10 embodiment.

FIG. 20 is a diagrammatic view of the commander's front instrument panel including a retractable map table/keyboard tray of the FIG. 10 embodiment.

FIG. 21A is a diagrammatic view of the retractable map table with integrated keyboard in its retracted position of the FIG. 10 embodiment.

FIG. 21B is a view similar to FIG. 21A with the map table in its usable position of the FIG. 10 embodiment.

FIG. 21C is a view similar to FIG. 21B with the top shutter of the slide moved back to provide access to the keyboard of the FIG. 10 embodiment.

### DETAILED DESCRIPTION OF PREFERRED EMBODIMENTS

The present invention provides a dashboard for a tactical truck systems utility vehicle. The dashboard is configurable depending upon the functions desired for the vehicle. There are various types of vehicles, such as trucks for moving equipment or personnel, trucks with a gun mount for a gunner, ambulances or other medical type of vehicles, and the like. The dashboard arrangement can be configured to fit properly with the overall vehicle configuration and the mission profile.

Embodiments one, two and three of FIGS., 1-9, are described below, and it should be noted that not all of the elements shown in the drawings have numbered parts in each figure.

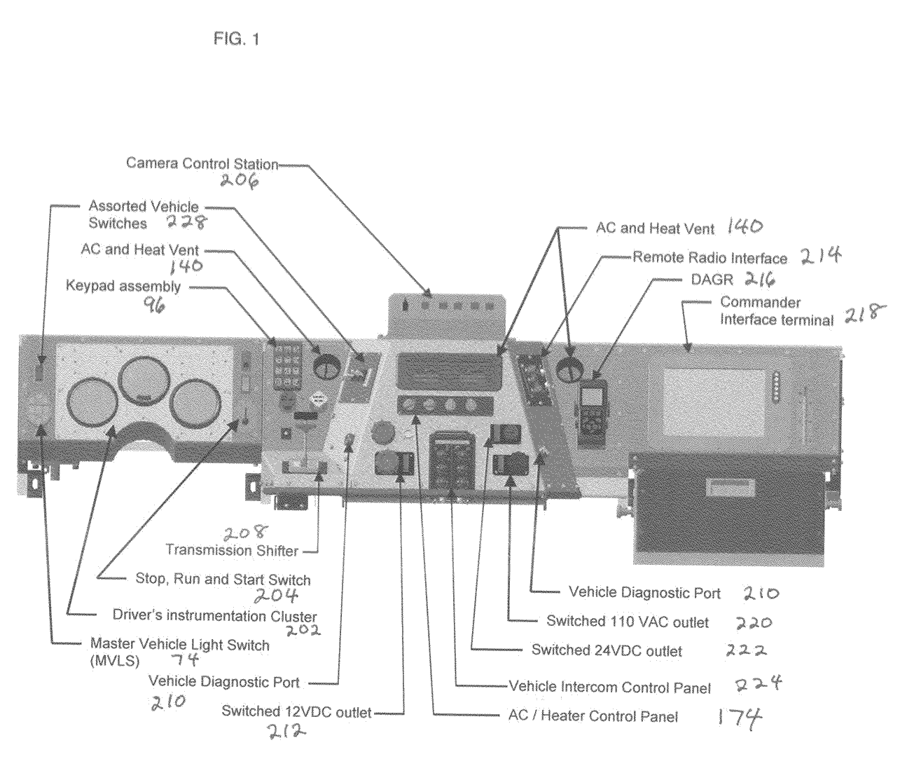

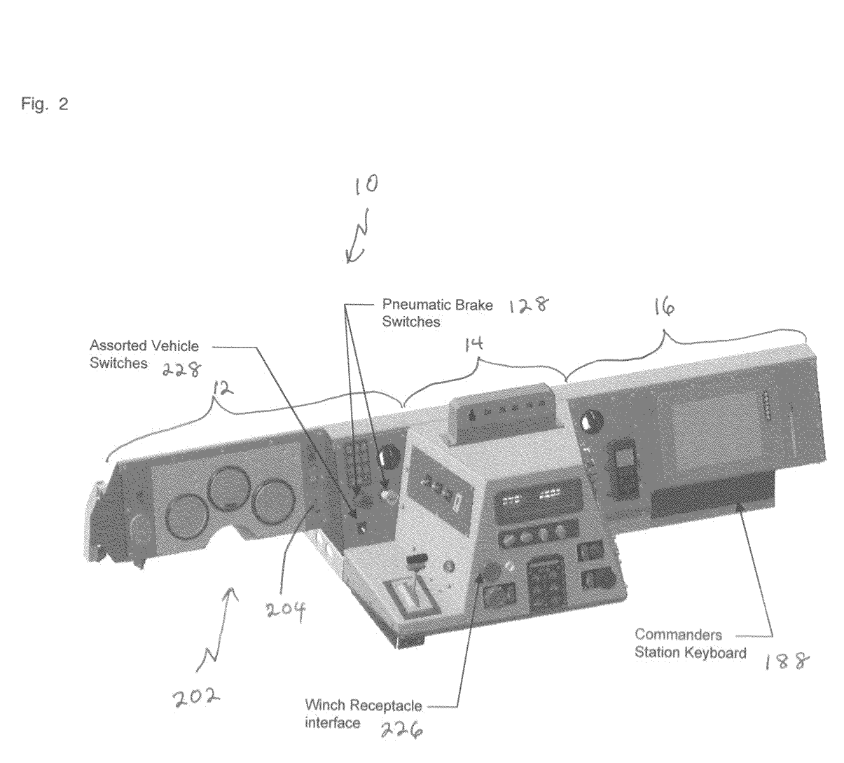

FIGS. 1 and 2 show a first embodiment of such a dashboard 10 which includes a driver section 12, a middle section 14, and a command section 16.

FIGS. 1, 2 and 7 show the driver's instrumentation cluster 202, a stop, run and start switch 204, a keypad assembly 96, AC and heat air vents 140, master vehicle light switch 74, camera control station 206, a transmission shifter 208, vehicle diagnostic port 210, switched 12V DC outlet 212, AC and heat vent 140, remote radio interface 214, DAGR 216, commander interface terminal 218, switched 110v AC outlet 220, switched 24v DC outlet 222, vehicle intercom control panel 224, AC/Heater control panel or cab climate control panel 174, brake switches 128 (which can be pneumatic), a keyboard 188 for the commander interface terminal 218, winch receptacle interface 226, and assorted vehicle switches 228.

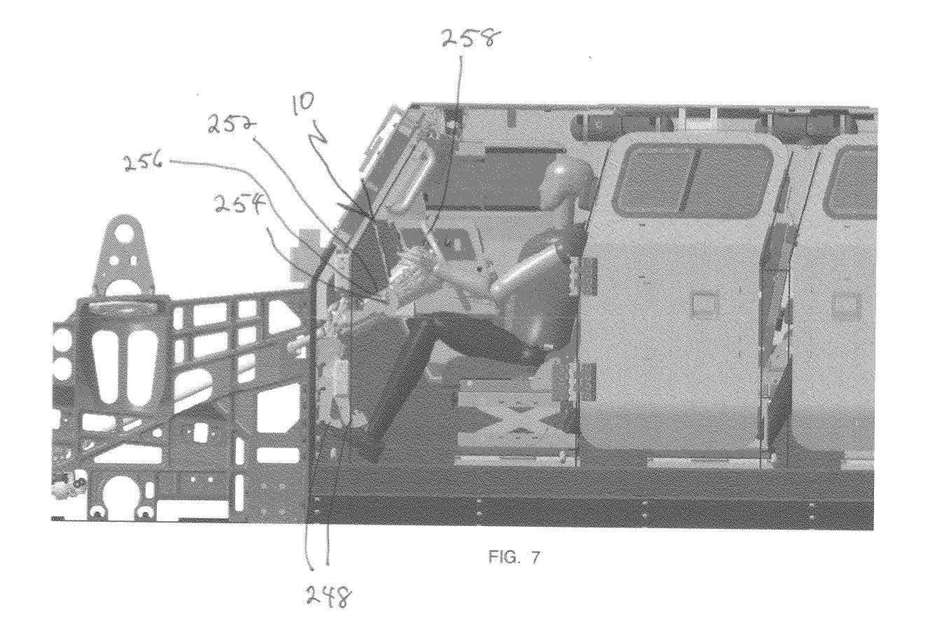

FIG. 7 is a side view of the first embodiment shown in FIGS. 1 and 2 which shows a driver 258 seated and the pedals 248 mounted to the dashboard 10, as well as the pivoted steering column 252. The steering column is pivoted at a pivot point where there is a handle 254 with an extending lever 256 for unlocking the steering column 252 so that it can be moved to the upward position. There is a steering wheel 258 which is mounted to be movable toward and away from the driver. The set of pedals 248 mounted to the dashboard are adjustable.

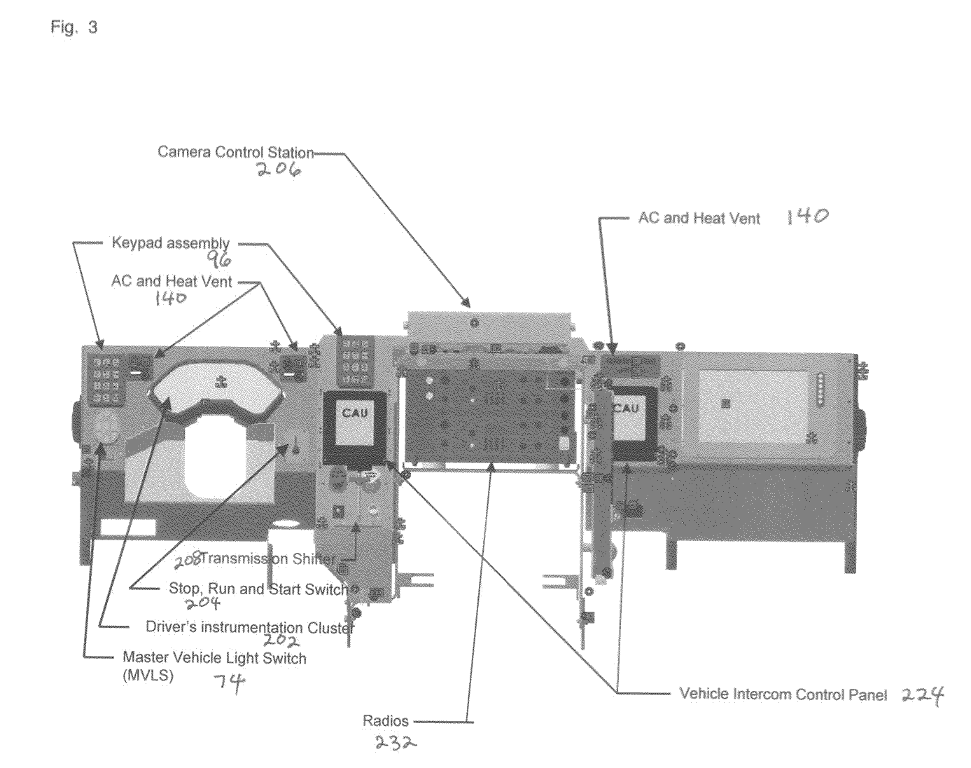

FIGS. 3, 4 and 8 show a second embodiment of such a dashboard 10 which includes a driver section 12, a middle section 14, and a command section 16.

These figures show the driver's instrumentation cluster 202, a stop, run and start switch 204, a camera control station 206, a keypad assembly 96, master vehicle light switch 74, a transmission shifter 208, vehicle diagnostic port 210, switched 12V DC outlet 212, AC and heat vent 140, commander interface terminal or operational display unit 218, auxiliary display unit (ADU) 230, switched 110v AC outlet 220, switched 24v DC outlet 222, vehicle intercom control panel 224, brake switches 128 (which can be pneumatic), a keyboard 188 for the operational display unit 218 and/or for the auxiliary display unit 230, winch receptacle interface 226, assorted vehicle switches 228, and assorted radios 232.

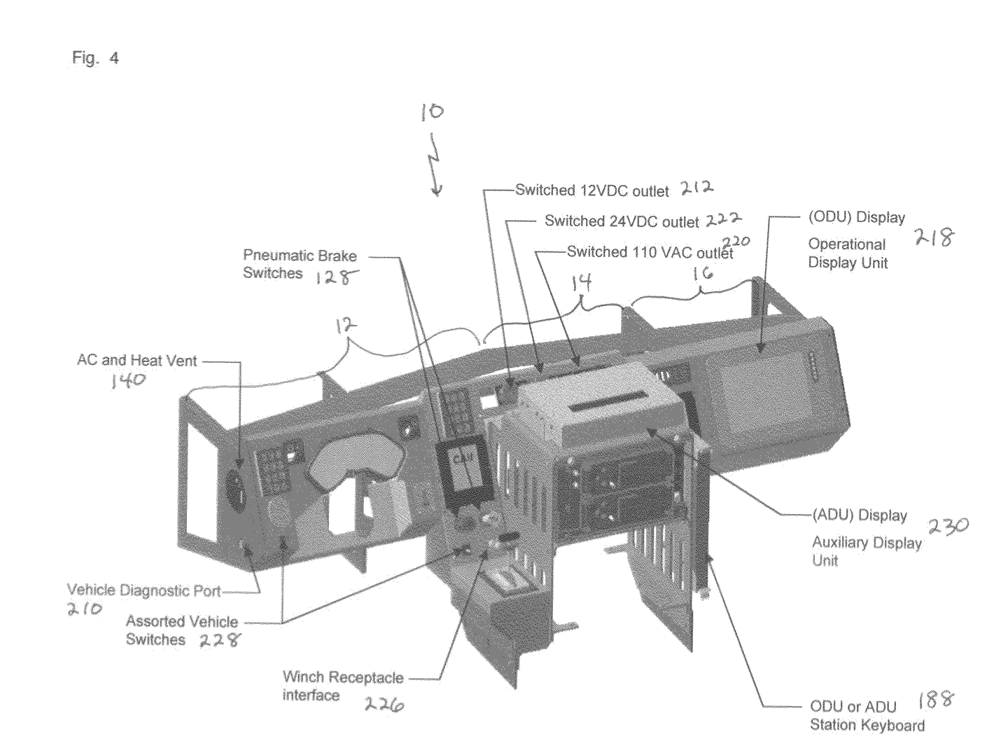

FIG. 8 is a side view of the second embodiment shown in FIGS. 3 and 4 which shows the cab without a driver and the pedals 248 mounted to the dashboard 10, as well as the pivoted steering column 252. The steering column is pivoted at a pivot point where there is a handle (not shown) with an extending lever (not shown) for unlocking the steering column 252 so that it can be moved to the upward position. There is a steering wheel 258 which is mounted to be movable toward and away from the driver. The set of pedals 248 mounted to the dashboard are adjustable.

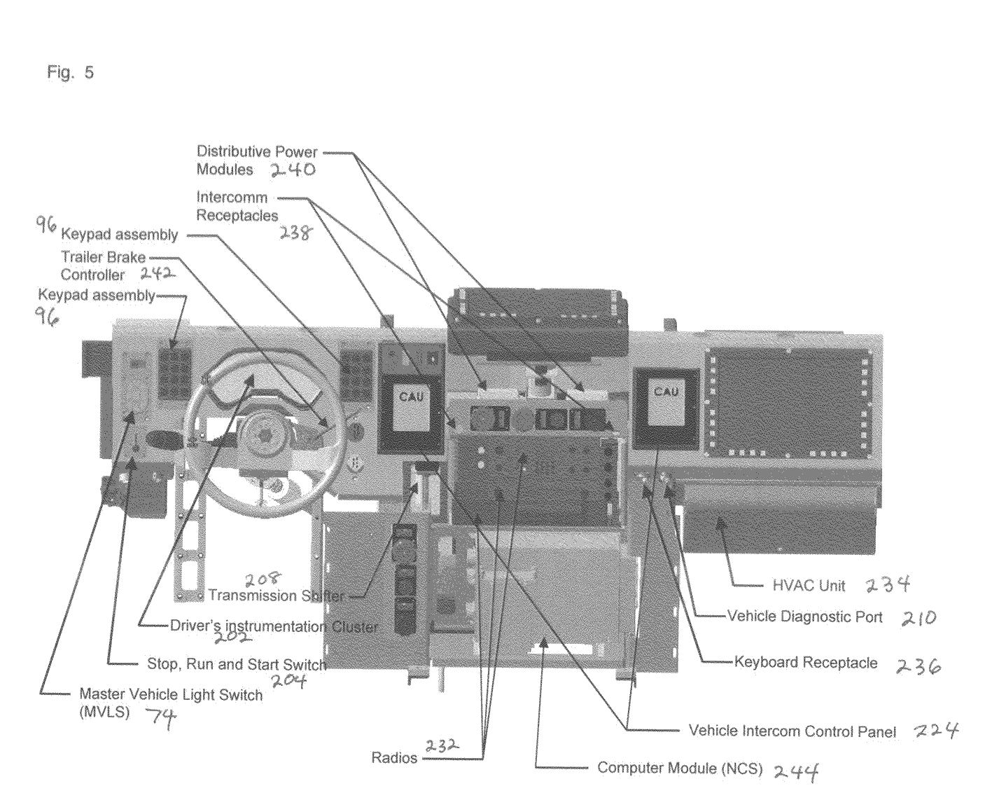

FIGS. 5, 6 and 9 show a third embodiment of such a dashboard 10 which includes a driver section 12, a middle section 14 and a command section 16.

These figures show the driver's instrumentation cluster 202, a stop, run and start switch 204, a keypad assembly 96, a master vehicle light switch 74, a transmission shifter 208, a vehicle diagnostic port 210, commander interface terminal or operational display unit 218, an auxiliary display unit (ADU) 230, a keyboard 188 for the operational display unit 28 and/or for the auxiliary display unit 230, vehicle intercom control panel 224, a keyboard receptacle 236, intercom receptacles 238, assorted radios 232, switched 12v DC outlets 212, switched 24v DC outlets 222, switched 110v AC outlets 220, an HVAC unit 234, distributive power modules 240, trailer brake controller 242, computer module (NCS) 244, brake switches 128 (which can be pneumatic), winch receptacle interface 226, and assorted vehicle switches 228 and main disconnect switch 246.

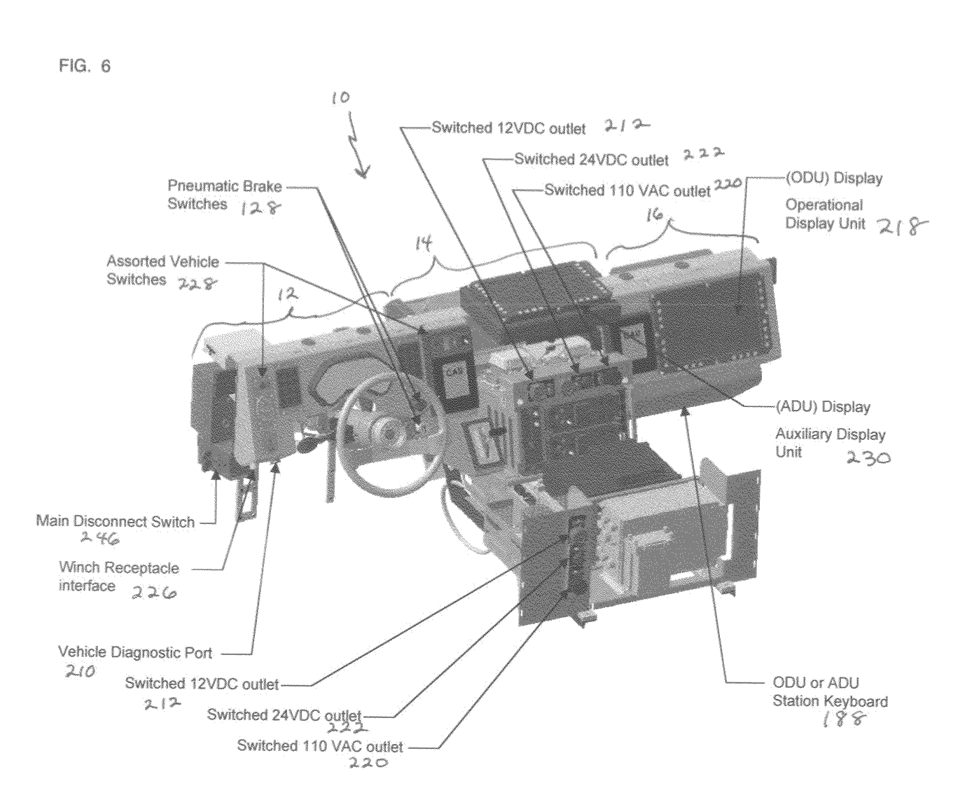

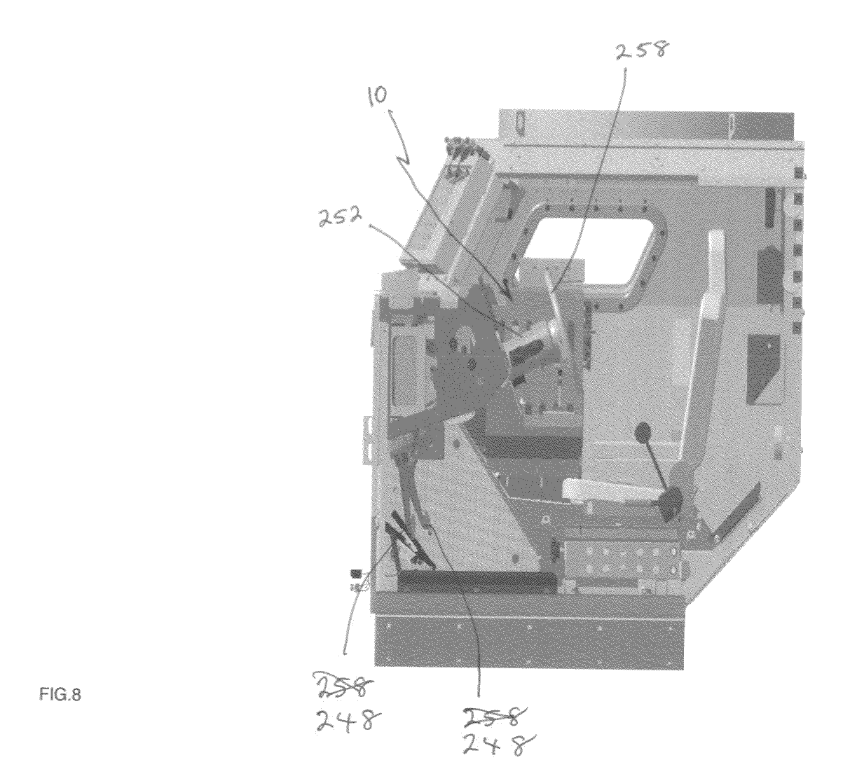

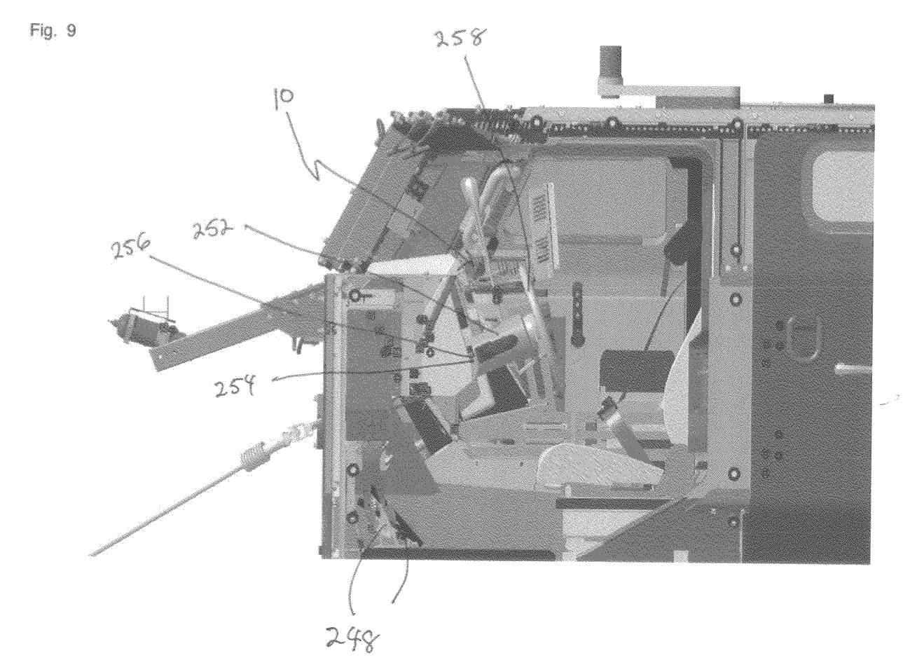

FIG. 9 is a side view of the third embodiment shown in FIGS. 5 and 6 which shows the cab without a driver and the pedals 248 mounted to the dashboard 10, as well as the pivoted steering column 252. The steering column is pivoted at a pivot point where there is a handle 254 with an extending lever 256 for unlocking the steering column 252 so that it can be moved to the upward position. There is a steering wheel 258 which is mounted to be movable toward and away from the driver. The set of pedals 248 mounted to the dashboard are adjustable.

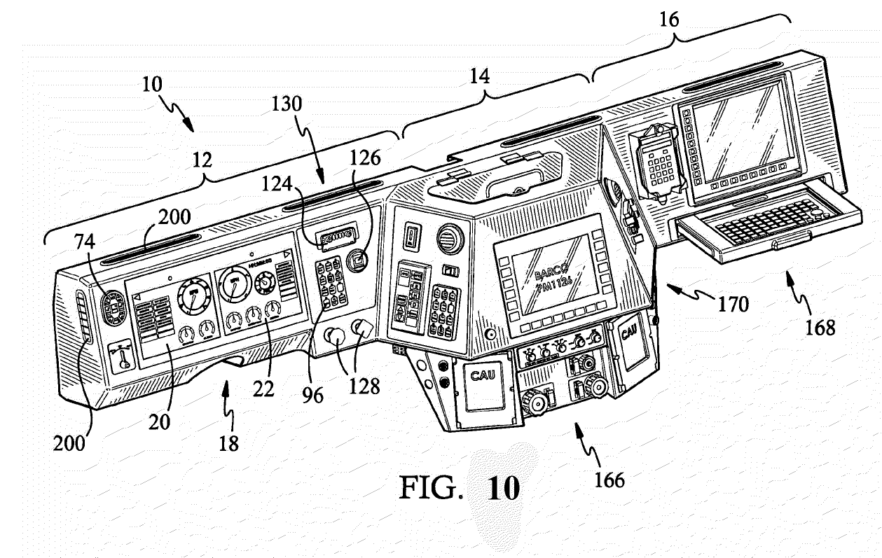

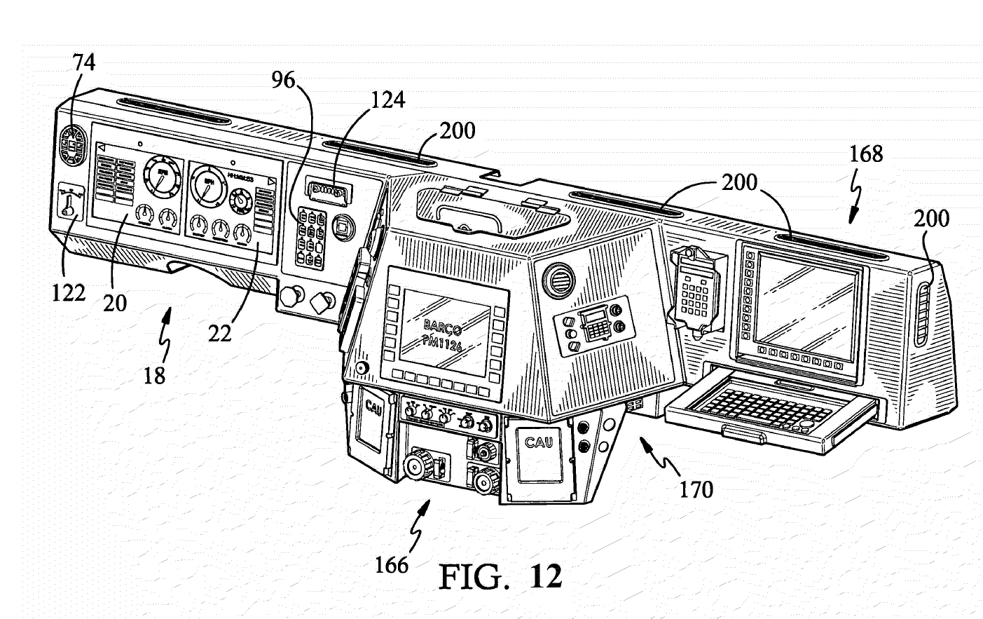

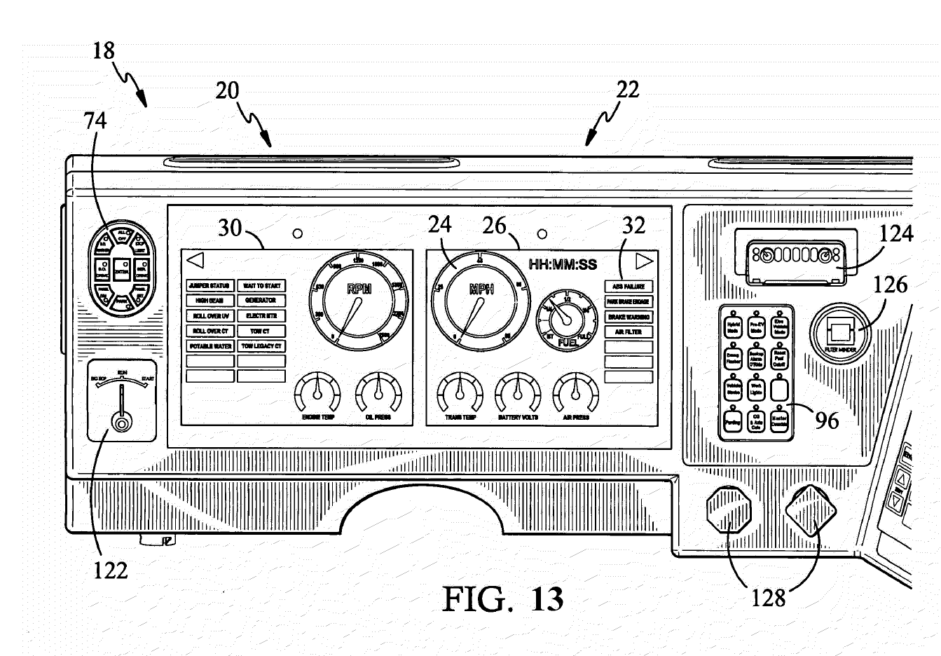

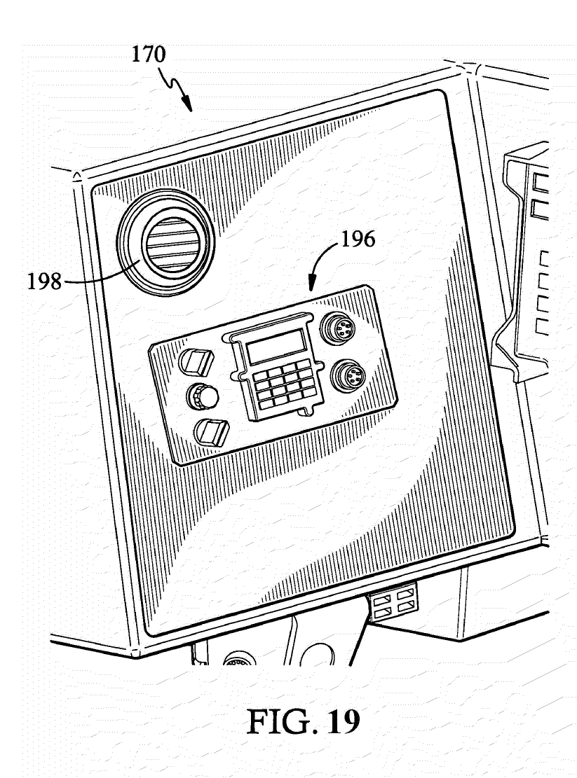

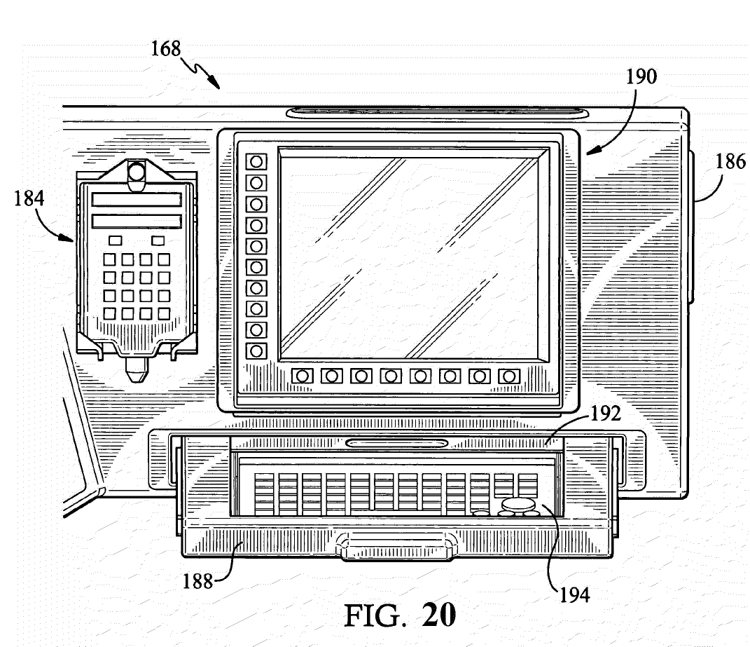

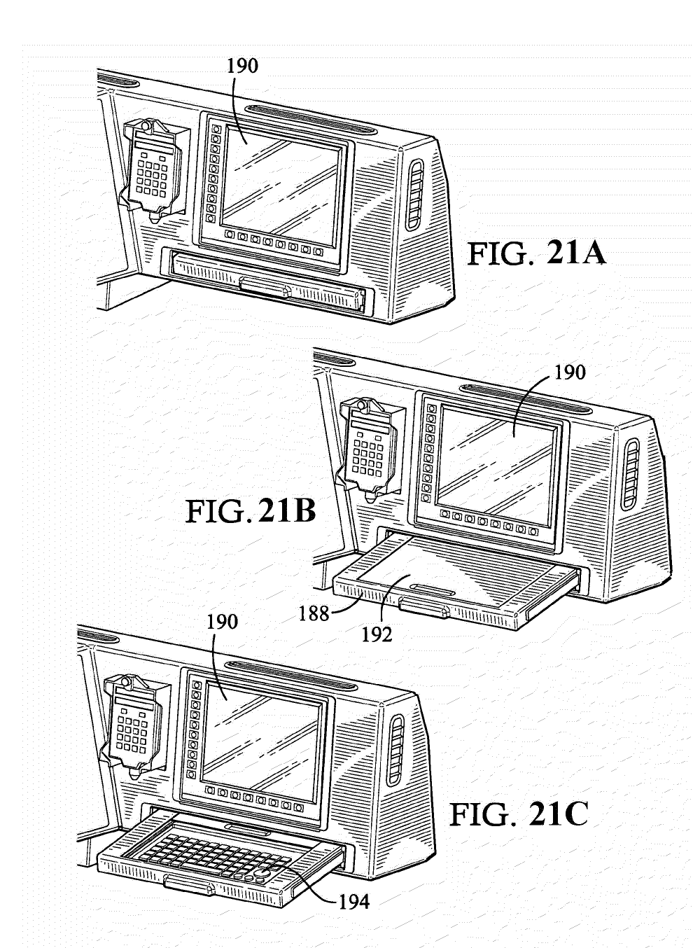

FIGS. 10-21C shown another embodiment of the invention.

The controls are designed and logically grouped based on functional relationship and ergonomics. For example, the vehicle mobility functions are co-located on one keypad, and utility functions are grouped into another switch console, and the like. This grouping of functions maximizes head up operations. This enables the crew to effectively accomplish all required control tasks, maximize head-up operation, and optimize sequential operation which reduces the operator overall workloads.

Controls are back lit where appropriate and provide touch sensory feedback when actuated. The controls associated with the display are either mounted on the display bezel or are mounted under the display like the keyboard and joystick. Controls are designed and logically grouped based on functional relationship with consideration to operator ergonomics. This grouping of functions maximizes head up operations as well as providing for the sharing of workloads between crew members.

There is a driver instrumentation cluster (DIC) which includes gauges that display fuel level, engine coolant temperature, engine oil pressure, engine tachometer, speedometer/odometer, air pressure for primary and secondary tank, air filter gauge, brake warning (indicating light), park brake status (indicating light) and battery percent of charge.

The DIC warning lights include engine temperature, headlight high beam, emergency brake status, ABS error,—left and right turn signal, wait to start, stop engine, check engine and transmission, air filter, brake warning, roll over warning for the UV and CT, Tow CT and others.

The DIC not only lights the correct warning lights, but has a built in audible alarm for low oil pressure, high coolant temp, park brake set, low fuel, low battery charge, low air pressure (primary and secondary) tanks, and others. The vehicle uses the Master Vehicle Light Switch (MVLS) for lighting controls. The emergency flasher switch is located on the utility keypad assembly, which is located to the right of the driver.

The gauges in the DIC are color coded to indicate safe, cautious and/or dangerous ranges. The gauges are oriented in such a way so that when the needles are pointing straight up, all indications are in the green or desirable operation range. This enables he driver a simple quick glance to verify that vehicle is operating in the desirable range.

The displays are mounted to be minimally intrusive into the crew space and the controls permit adjustment of contrast and brightness and the display supports blackout mode. The displays are touch screen as well as keyboard driven and the keyboards fold or slide out of the way when not needed. The displays are night-vision compatible.

In one embodiment, the display controls are located on the display bezel and the hand does not obscure the display when the bezel key is pressed. The keyboard and joystick are located below the display thereby providing an open view of the screen when these controls are in use.

Dashboard controls are located in clusters around the appropriate crew station, As an example, the driver has controls to shift the vehicle, control the vehicle height (CTIS) and other driver aids. The commander station has access to IT applications, radio control, DVE video display, and it can also act as a control station for the optional remote control weapons system.

Emergency messages are displayed in the message area of the driver cluster or on the vehicle management display located on the console to the right of the driver. The commander can monitor the vehicle management application from the commander's work station.

All controls are directly in front of the user of the display with the exception of the vehicle management display that is mounted to the right of the driver's position on the central console. The driver can get an acceptable viewing angle with minimal parallax error by sitting fully back in the seat.

From a pushbutton on the driver's utility keypad, a request is sent out via a databus to the suspension controller. The suspension controller performs the calculation and provides the center of gravity (CG) and axle-load information via the databus to the DIC for display on the LCD display in a text format and recorded in the vehicle management system (VMS) software. Optionally, the vehicle management software can be enhanced to provide this information in a graphical format if it is useful for the operator.

A receptacle is placed on the dashboard to allow the connection of the winch handheld control device. Once the winch handheld device is connected, the operator is allowed to extend and or retract the winch cable regardless of which end of the vehicle the winch is installed.

Another example of the DIC is a display showing the percent of charge remaining in the Hybrid batteries. This information is monitored via the Hybrid Control Module and is communicated via a network to the DIC. In addition to a gauge on the DIC the percent of charge is displayed on the LCD that is located in front of the driver. All of the vehicle's J1939 data bus traffic is monitored via the VMS software.

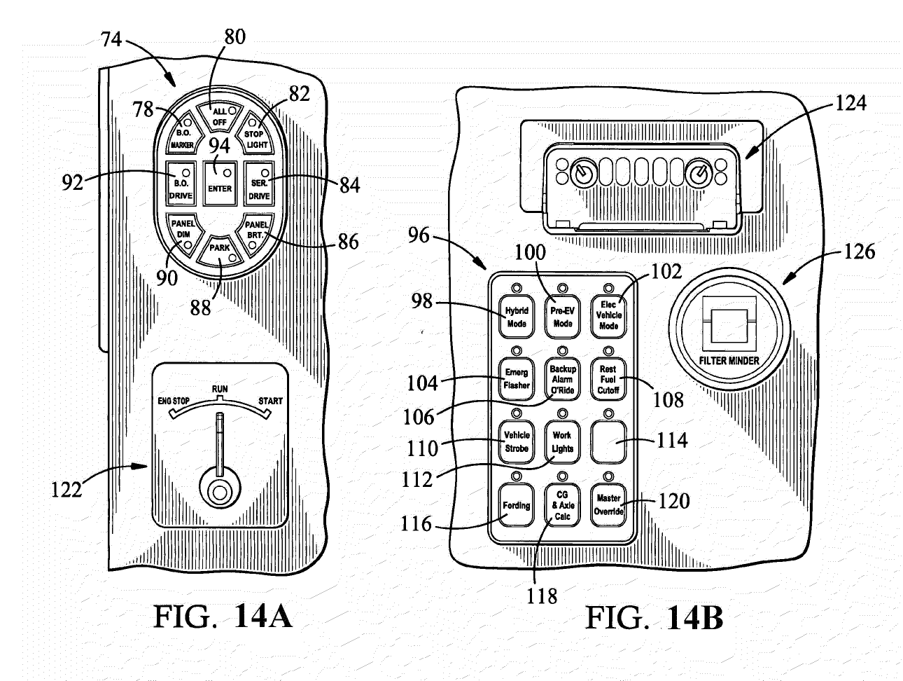

Directly in front of the driver is the driver's front view panel 18 (see FIGS. 10-13) which includes two main driver displays 20 and 22 which provide the driver with basic information such as the vehicle speed display 24 and next to it is the fuel gauge 26. At the bottom of the primary displays 20 and 22 are a plurality of additional driver gauges 28 of various types. (See FIGS. 14-16) There is an RPM display 34 on the left display panel 20. Below the RPM display 34 there is an engine temperature gauge 36 and next to it is an oil pressure gauge 38. On the right display panel 22 and below the speed display 24 and fuel gauge 26, there are a transmission temperature gauge 40, a battery volts gauge 42 and an air pressure gauge 44

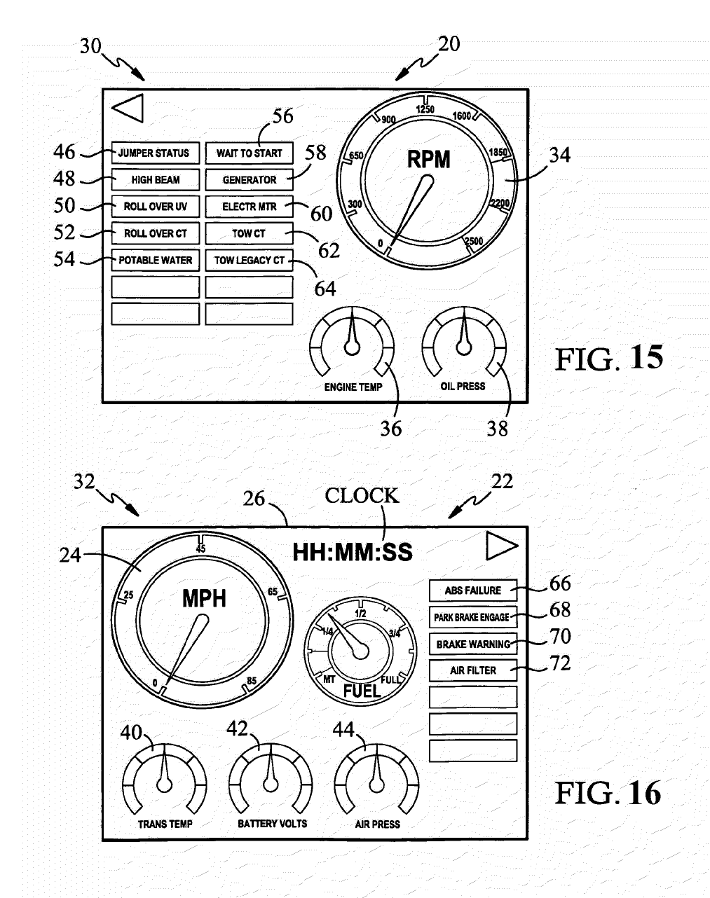

In addition to the gauges, the main driver displays 20 and 22 (see FIGS. 15-16) also have two banks of warning light including a first bank of warning lights 30 and a second bank of warning lights 32. The first bank of warning lights 30 include the following: jumper status 46, high beam 48, roll over UV 50, roll over CT 52, potable water 54, wait to start 56, generator 58, electric motor 60, tow CT 62 and tow legacy CT 64. The second bank of warning lights 32 include the following: ABS failure light 66, park brake engage light 68, brake warning light 70 and air filter light 72.

Examples of the utility of such lights are provided, for example, by the ABS failure light 66. The ABS built in test results are provided to the crew in that the ABS fault indicator light 66 is on the driver's side of the dashboard and it turns red during the test and under fault conditions and turns off when the test is complete with no errors found.

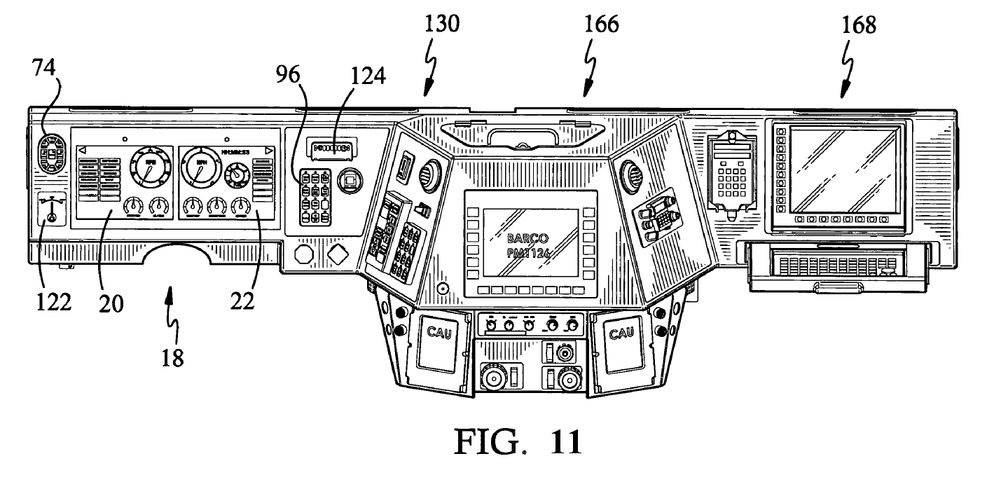

There is a master vehicle light switch MVLS 74 to the left of the driver's front view panel 18 below which is the keyless start switch 76. (See FIG. 11) The MVLS 74 has the following buttons/switches: B.O. marker 78, All Off 80, Stop Light 82, Ser. Drive 84, Panel Brt. 86, Park 88, Panel Dim 90, B.O. Drive 92 and Enter 94. All indicators and gauges are illuminated in service mode. The MVLS has a Panel Bright button 86 and a Panel Dim button 90. The vehicle driver has control using these control buttons as to the illumination level in any driving condition. This includes all dashboard components, i.e., MVLS 74 LEDs, Utility Keypad 96, Mobility Keypad, EATON PBSDC and the DIC. An appendix is attached showing some of the functions and conditions of the parts of the Utility Keypad and the Mobility Keypad.

There is a utility keypad 96 located to the right of the driver's right display panel 22 (see FIG. 11). This utility keypad 96 has the following; Hybrid mode 98, Pre-EV mode 100, Electric vehicle mode 102, Emergency flashers 104, Backup alarm override 106, Reset fuel cutoff 108, vehicle strobe 110, work lights 112, spare 114, Fording 116, CG & axle calc 118 and master override 120.

Functionally related controls and displays include the start switch, the Master Vehicle Light Switch (MVLS), the mobility and utility keypads, the Collision Warning System (CWS) and the transmission controller. The start switch is the same as is used on the HMMWV and is ordered from left to right as ENG STOP, RUN; START. The MVLS is a new blackout lighting control switch that is standard for many vehicles in the tactical wheeled vehicle fleet, and has 9 keys ordered from left to right and top to bottom as B.O. MARKER, ALL OFF, STOP LIGHT, B.O. DRIVE, ENTER, SER. DRIVE, PANEL DIM, PARK, PANEL BRT. The Mobility Keypad pushbuttons are arranged in a matrix of 4 rows by 3 columns, and ordered from left to right and top to bottom as ON-ROAD, HARD PACK SNOW/ ICE, (blank/ spare), MODERATE OFF-ROAD, DEEP MUD, DEEP SAND, LOW RANGE, TOW - NEUTRAL, HIGH RANGE, MIN RIDE HEIGHT, MAX RIDE HEIGHT, EMERGENCY RESET. The Utility Keypad pushbuttons are arranged in a matrix of 4 rows by 3 columns, and ordered from left to right and top to bottom as HYBRID MODE, PRE-EV MODE, ELECTRIC VEHICLE MODE, PARK BRAKE, VEHICLE STROBE, BACKUP ALARM OVERRIDE, VEHICLE JUMP START, FORDING, CG & AXLE CALC., WORK LIGHTS, RESET FUEL CUTOFF, HILL DEFENSE. The CWS controls and displays consist of 2 units. The Driver Display Unit is located on the driver's front dashboard to indicate blockage in front of the vehicle, and a Side Sensor display is located on the driver's right side dashboard panel to indicate blockage on the right side of the vehicle. The vehicle transmission control panel is arranged vertically in 2 columns. The first column is ordered from top to bottom as APG, SERVICE, SHIFT UP, SHIFT DOWN. The second column is ordered from top to bottom as ePTO, R (reverse), N (neutral), D (drive), MANUAL.

The Start switch 122 is below the MVLS 74. The Collision Warning System (CWS) DDU 124 is above the utility keypad 96. There is an air filter display 126 adjacent the utility keypad 96. There are brake switches 128 under the utility keypad 96.

There is a driver's side view panel 130 (see FIG. 14) which includes a collision warning system SSD 132, an EATON transmission controller 134, a mobility keypad 136 a lateral control 138 and an air vent (or AC and heat vent) 140. The mobility keypad includes: On-road 142, hard pack snow/ice 144, moderate off-road 146, deep mud 148, deep sand 150, spare 152, low range 154, tow-neutral 156, high range 158, Minimum ride height 160, maximum ride height 162 and emergency deflate 164.

There is a common area instrument cluster panel 166 (see FIG. 15) which includes a vehicle management display 172, a cab climate control panel, a winch control receptacle, a vehicle intercom controller 178, a bank of convenience outlets for 12 and 24 VDC and 110 VAC, and a vehicle intercom controller receptacles bank 182.

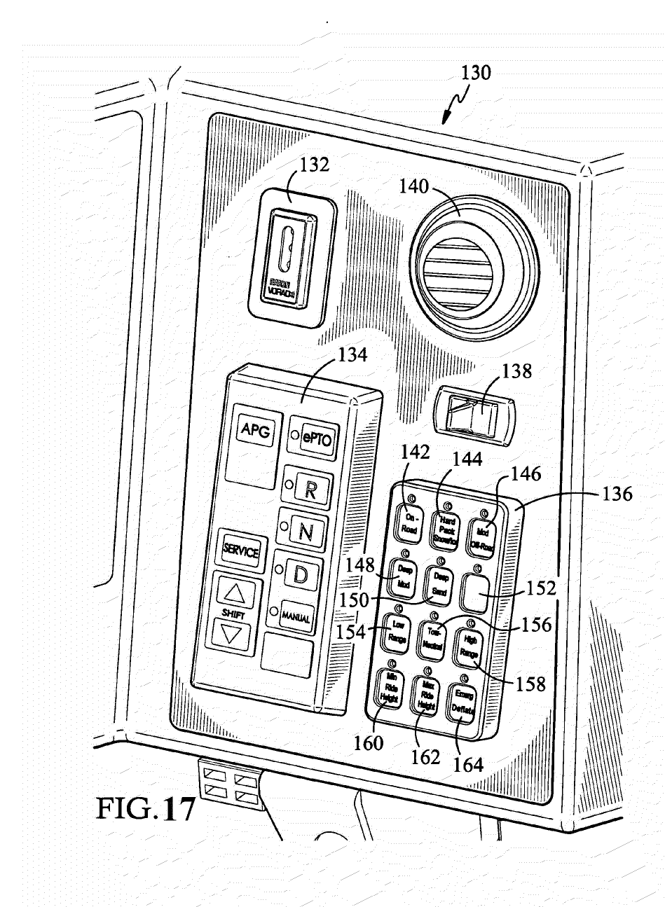

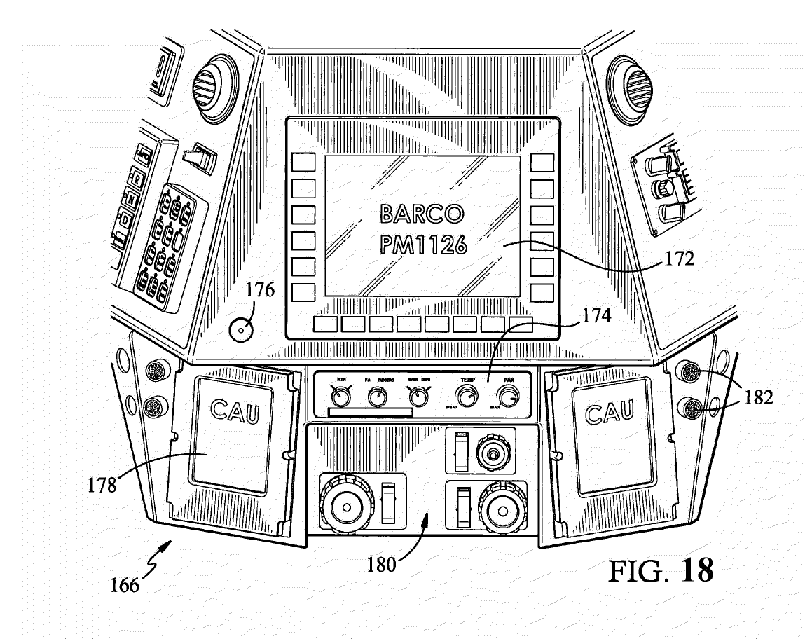

There is a commander's front instrument panel 168 (see FIG. 17) and a commander's side instrument panel 170 (see FIG. 16). The commander's front instrument panel includes an EPLR (enhanced position location reporting system) URO (user remote option) 184, a retractable map table with integrated keyboard, a FBCB2 (Force XXI Battle Command Brigade and Below which provides situational awareness and command and control to the lowest tactical echelons. It facilitates a seamless flow of battle command information across the battlespace, and interoperates with external command and control and sensor systems, such as ATCCS. The end result is a vertical and horizontal integration of the digital battlespace and the brigade-and-below tactical unit levels) display panel for commander information 190 and an air vent 186. FIGS. 18A, 18B and 18C show the integrated map table 188 in various positions. The integrated map table/keyboard assembly 188 is mounted so it can slide in and out to provide a shutter panel 192 which can be used as a map/writing table. When the table is slid out in addition to being used as a writing table, the shutter panel 192 can be slid while the table remains out, and there is a keyboard 194 which is located inside the table and which is then accessible.

The commander's side instrument panel 170 includes a remote SINCGARS radio interface 196 and an air vent 198. (SINCGARS is a single channel ground and airborne radio system which is a recent family of VHF-FM combat net radios which provide the primary means of command and control for infantry, armor and artillery units. They are used with VRCUs (vehicle remote control unit) which permit remote control of single or dual SINCGARS radios in vehicular applications. Using this reduces vehicle cabin space and weight claims issues in support of the SINCGARS radio installation. SINCGARS is a new family of VHF-FM combat net radios which provides the primary means of command and control for Infantry, Armor and Artillery Units. SINCGARS is designed on a modular basis to achieve maximum commonality among the various ground and airborne system configurations.

There are a plurality of fresh air vents such as vents 140 in the driver's side panel and 198 in the commander's side panel. In addition there are a plurality of defrost vents 200 along the top and side of the dashboard as shown, for example, in FIGS. 7 and 9.

The present invention provides:
improved ergonomics for 5% to 95% of the soldiers and includes reach and visibility of instruments from all seating positions;
compact, higher density instrument cluster, with improved readability and lighter weight, lower cost;
smaller size, due to cab reductions, compressed more user information per square foot, and size reduced by 25%;
lighter weight structure by 25%, and modular structure to reduce install and repair time by a factor of two;
modular structure which adapts to build variations and errors in construction by using internal adjustments and attachment features;
increased density of equipment included, faster remove and replace (5 minutes on average any component), improved operator protection (cover on the dash bottom) during a blast event;
ergonomic improvements include wider range of reach, natural location of functions;
incorporates additional functions, improve adjustable (mechanical slots) pedal placement, dead pedal for off-road driving, natural steering location for ergonomic center line, improved comfort curve;
combat egress for steering column, up angle of 20 degrees, allows soldier with combat vest and gun clips (ammo) to exit quickly with weapon.
lower part of dash is cut away for soldier's knees to allow exiting with wheel up position.
all parts of dash moved closer to soldier to remove need for lean forward reach; and
incorporated high volume HVAC for legs, chest, front glass to improve ergonomics and reduce cabin temperatures and increase combat comfort zone operation.

The dashboard in the second and third embodiments is built like a wing with a set of ribs and skin, provides manufacturing simplicity, simple installation, R&R of damaged pieces, improved access to components and wiring behind the dash;

The dashboard wing structure is stronger due to increased strength from interlocked elements which transfer stresses across the whole unit into the cab cowl and firewall.

It is to be understood that the above-described embodiments are simply illustrative of the principles of the invention. Various and other modifications and changes may be made by those skilled in the art which will embody the principles of the invention and fall within the spirit and scope thereof.

1. A dashboard for a tactical vehicle having a driver position and a passenger position, comprising:
a plurality of panels removably attached together to form a dashboard having a plurality of displays and warning lights viewable from the driver position to provide information for the driver of a vehicle, one of said panels being located in front of the vehicle driver position and having a driver instrument cluster.

2. A dashboard as in claim 1 wherein said panels are constructed of ribs with a cover.

3. A dashboard as in claim 2 wherein the panels are removably bolted to the ribs.

4. A dashboard as in claim 2 wherein the panels are removably attached to the ribs with quick release devices.

5. A dashboard as in claim 1 further comprising a steering column at the vehicle driver position which projects through a slot in the driver position panel.

6. A dashboard as in claim 5 wherein the steering column is mounted to be moved upwardly from a driving position to an egress position.

7. A dashboard as in claim 6 wherein the upward movement of the steering column is arranged to be up to 20 degrees.

8. A dashboard as in claim 7 wherein the lower part of the driver position panel is cut away to provide space for the driver's knees for the driver to exit a vehicle quickly when the steering column is in the egress position.

9. A dashboard as in claim 1 further comprising a plurality of driver pedals.

10. A dashboard as in claim 9 wherein there is an acceleration pedal, a brake pedal and a “dead” pedal for use during off road driving.

11. A dashboard as in claim 1 wherein the driver instrument cluster is in the shape of an inverted arc.

12. In a tactical vehicle having a driver position and a passenger position, the improvement of a dashboard, comprising:
a plurality of panels removably attached together to form a dashboard having a plurality of displays and warning lights viewable from the driver position to provide information for the driver of a vehicle, one of said panels being located in front of the vehicle driver position and having a driver instrument cluster.

13. The improvement as in claim 12 wherein said panels are constructed of ribs with a cover.

14. The improvement as in claim 13 wherein the panels are removably bolted to the ribs.

15. The improvement as in claim 12 further comprising a steering column at the vehicle driver position which projects through a slot in the driver position panel.

16. The improvement as in claim 15 wherein the steering column is mounted to be moved upwardly from a driving position to an egress position.

17. The improvement as in claim 16 wherein the upward movement of the steering column is arranged to be up to 20 degrees.

18. The improvement as in claim 17 wherein the lower part of the driver position panel is cut away to provide space for the driver's knees for the driver to exit a vehicle quickly when the steering column is in the egress position.

19. The improvement as in claim 12 further comprising a plurality of driver pedals which include an acceleration pedal, a brake pedal and a “dead” pedal for use during off road driving.

20. A dashboard for a tactical vehicle having a driver position and a passenger position, comprising:
a. a plurality of displays and warning lights viewable from the driver position to provide information for the driver of a vehicle;
b. a plurality of displays and communications devices viewable from the passenger position to provide information for a passenger sitting in the passenger seat of such vehicle;
c. a visual display unit to provide information to an occupant of the vehicle; and
c. vehicle intercom control devices accessible for use from the driver position and from the passenger position of the vehicle.
